(19) United States
(12) Patent Application Publication
(10) Pub. No.: US 2008/0195268 A1
(43) Pub. Date: Aug. 14, 2008

(54) Implement control system and method of using same

(75) Inventors: Glen Alan Sapilewski, Redwood City, CA (US); Michael Lee O'Connor, Redwood City, CA (US); Manou Serres, Redwood City, CA (US); Michael Lyle Eglington, Burlingame, CA (US)

Correspondence Address: JERRY RICHARD POTTS, 3248 VIA RIBERA, ESCONDIDO, CA, 92029, US

(73) Assignee: Novariant, Inc., Menlo Park, CA (US)

(21) Appl. No.: 11/704,583

(22) Filed: Feb. 9, 2007

(51) Int. Cl. G05D 1/00

(52) U.S. Cl. 701/23

(57) ABSTRACT

An implement steering system includes at least one sensor for providing an indication of tilt associated with an implement as it traverses along an implement path of travel and at least another sensor for providing an indication of the current position of the implement as it traverses along the implement path of travel. A processor provides an implement drift correction signal in response to the indication of tilt and the indication of current position in order of facilitate correcting the implement path of travel so it corresponds to a desired path of travel, while an implement steering arrangement which is responsive to the drift correction signal causes the implement path of travel to be corrected so it corresponds to the desired path of travel as the implement is pulled through an open field by an implement pulling vehicle.

### BACKGROUND OF THE INVENTION

Towed and hitched implements, such as planters and cultivators and like implement devices are known to drift in uneven soil conditions, side hills, planting beds and particularly during contour plowing. Therefore, it would be highly desirable to have a new and improved implement control system and method which compensates or causes an implement to be actively steered so as to substantially reduce or completely eliminate losses caused by drifting due to uneven soil conditions, side hill plowing, and in particular, drift caused during contour plowing.

### SUMMARY OF THE INVENTION

The implement control system of the present invention provides a unique and novel method of steering and controlling an implement so as to substantially reduce or completely eliminate losses caused by drift due to uneven soil conditions, side hill plowing, and particularly during contour plowing. An implement control system includes, at least, one sensor for providing an indication of tilt associated with an implement as it traverses along an implement path of travel in an open field having variable soil conditions and, at least, another sensor for providing an indication of the current position of the implement as it traverses along the implement path of travel. An implement control manager processor provides an implement drift correction signal in response to the indication of tilt and the indication of current position in order of facilitate correcting the implement path of travel so it corresponds to a desired path of travel. An implement steering arrangement, which is responsive to the drift correction signal, causes the implement path of travel to be corrected so it corresponds to the desired path of travel as the implement is pulled through the open field by an implement pulling vehicle, where the implement pulling vehicle traverses through the open field under the control of a GPS-based vehicle control manager processor.

### BRIEF DESCRIPTION OF THE DRAWINGS

The above-mentioned features and steps of the invention and the manner of attaining them will become apparent, and the invention itself will be best understood by reference to the following description of the embodiments of the invention in conjunction with the accompanying drawings wherein:

FIG. 1 is a system block diagram of an implement control system, which is constructed in accordance with the present invention;

FIG. 2 is a system block diagram of another implement control system, which is constructed in accordance with the present invention;

FIG. 2A is a tilt sensor employed by another implement control system, which is constructed in accordance with the present invention;

FIG. 3 is a diagrammatic illustration of the system of FIG. 1 incorporated between an implement pulling vehicle and an implement;

FIGS. 4-6 are diagrammatic illustrations of various field conditions which can result in unwanted and undesired implement drift;

FIG. 7 is a comparison chart which illustrates the effects of drift in a towed planter relative to a desired towing path, and the improved accuracy of the towed planter through gently rolling hills through application of the implement control system of FIG. 1 and its novel method use;

FIGS. 8A-8B are simplified flow charts which illustrate the method of controlling implement steering to follow a curved trajectory path;

FIG. 9 is a greatly simplified flow diagram of a coulter alignment algorithm utilized by the implement control system of FIG. 1;

FIG. 10 is a greatly simplified flow diagram of an implement control algorithm utilized by the implement control system of FIG. 1 with indirect implement tilt measurements;

FIG. 11 is a greatly simplified flow diagram of another implement control algorithm utilized by the implement control system of FIG. 2 with direct implement tilt measurements;.

FIG. 12 is a system block diagram of yet another implement control system, which is constructed in accordance with the present invention;

FIG. 13 is a system block diagram of still yet another implement control system, which is constructed in accordance with the present invention; and

FIG. 14 is a greatly simplified flow diagram of another implement control algorithm utilized by the implement control system of FIG. 2 with direct implement tilt measurements for curved path trajectories.

### DETAILED DESCRIPTION OF THE INVENTION

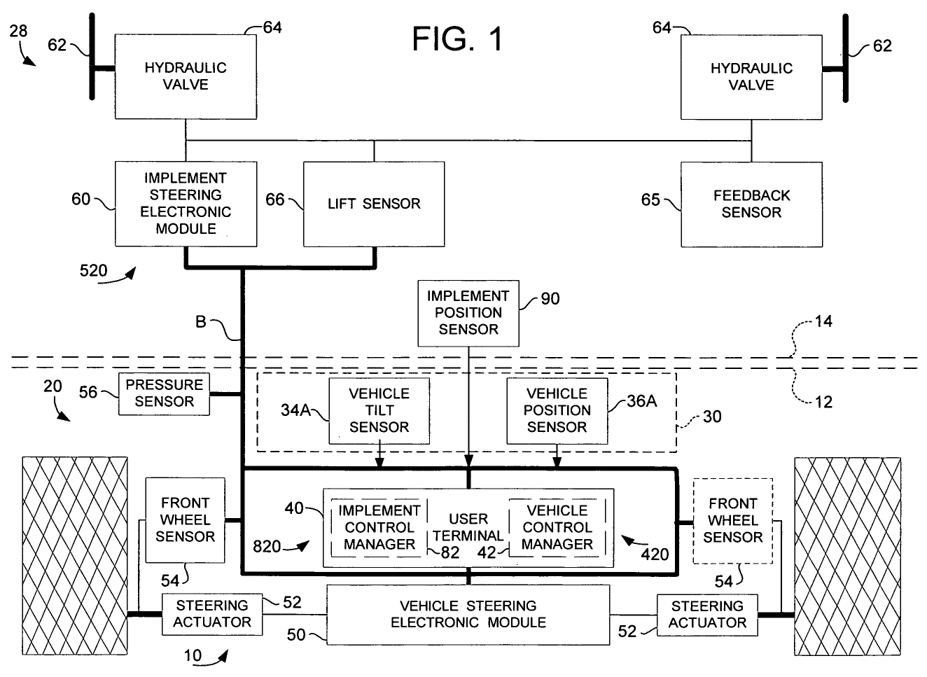

Referring now to the drawings and more particularly to FIG. 1 thereof, there is illustrated an implement control system 10, which is constructed in accordance with a preferred embodiment of the present invention. The implement control system 10 compensates and corrects for unwanted and undesired implement drift caused by uneven soil conditions, side hills, planting beds, contours and other similar conditions, which helps to reduce costs while improving yields by ensuring precise placement of inputs.

Side dressing, ridge till, and strip till are all examples of farm practices that become practical and efficient with the implement control system 10 of the present invention. In this regard, the implement control system 10 helps reduce crop damage and compaction by ensuring true repeatability across all types of farm operation, including: field prep, planting, cultivating, spraying and harvesting. The implement control system 10 when used in accordance with a novel method of use, as will be described hereinafter in greater detail, ensures that a tractor 12 and an associated pulled implement 14 are actively controlled and directed along a desired path of travel within an open field.

Before discussing the implement control system 10 in greater detail it may be beneficial to briefly review the state of farming operations utilizing navigation systems. In this regard, U.S. patent application 20060271348 published on Nov. 30, 2006, provides a description of how navigation receivers are utilized in vehicles to assist in various farming operations. For example, the '348 application provides that a navigation receiver is connected to a farming vehicle for automatically steering during plowing, planting, harvesting and other uses. The '348 application further provides that other devices may also be provided in the equipment, such as displays and associated processors for indicating operation of various vehicle components. In the described farming example, separate displays for operation of attached components, such as sprayers are provided, while the different processor and associated programs are described as providing information to a user using the same or different operating systems independently run on each device. For example, the '348 application describes a navigation receiver operating under a Linux operating system, and an application for controlling spraying of herbicides or pesticides operating pursuant to a Palm or Pocket PC operating system. In short then, the prior art recognizes the complexity of not only the farming equipment itself, but also of the various operating systems, application programs and displays that may be made available to a user while using such automated equipment.

While such systems may recognize the complexities of farming operations and even the need to control the different types of components which may be attached to a tractor 12 or like pulling vehicle, none of the prior art control systems teach or suggest how to control or compensate for the drift or tilt of an implement 14 or tool as it is pulled or traverses through an open field F (FIG. 5). Stated otherwise, as a farmer plants, cultivates sprays, fertilizes, and harvests crops, the ability to accurately steer a vehicle has a significant impact on yield, as well as on input costs. In an attempt to help solve this problem, GPS operated vehicles have been implemented to steer these vehicles very accurately. However, particularly in an open field with variable soil conditions, controlling the location of the tractor 12 is not sufficient, since the location of many of the different types of tools that may be attached to the tractor 12 have some degree of freedom to move from side to side. Such movement, due to open field conditions can vary significantly, resulting in unwanted and undesired yield lost.

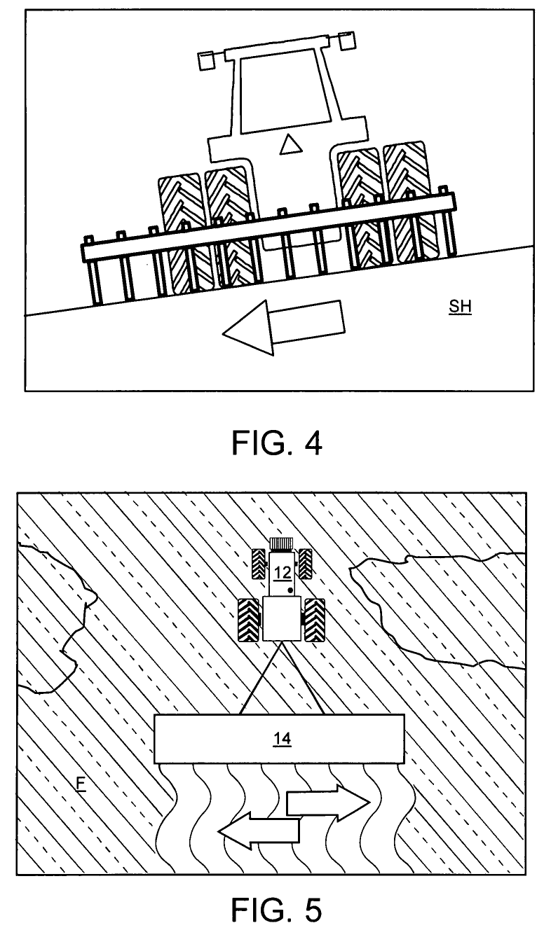

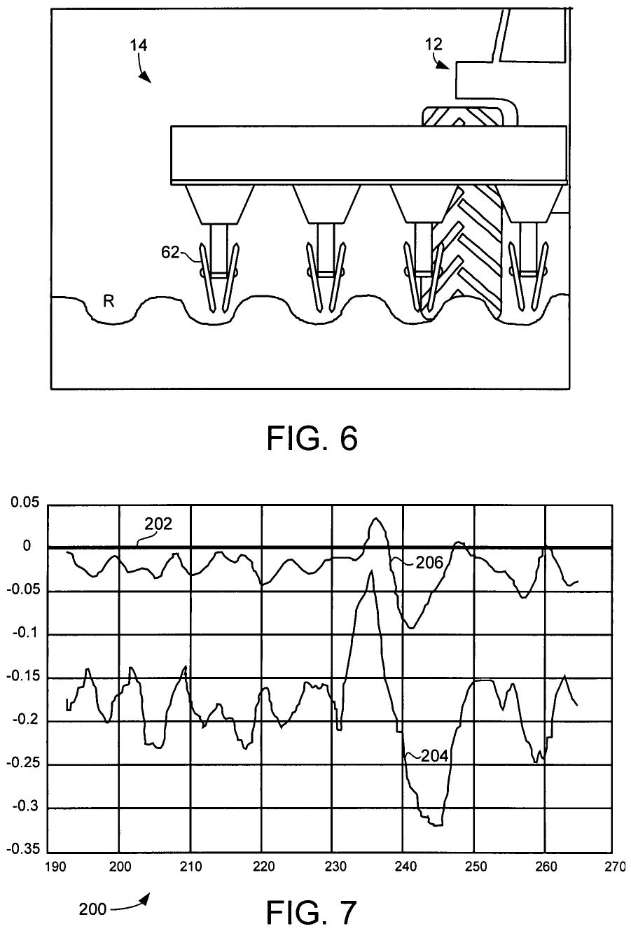

Some have recognized this problem and as a result some systems have been proposed to control an implement using GPS or other position sensors. For example, U.S. Pat. No. 6,865,465 describes a system which includes a tractor steering system and an implement steering system. However, none of these proposed systems account for implement tilt, nor do they solve the problem with curved or contour plowing, or how to easily and quickly adjust the trajectory of an implement relative to its associated tractor trajectory in variable soil conditions, such as sliding on side hills SH as best seen in FIG. 4; walking across old rows or sub-surfaces as best seen in FIG. 5; or climbing or jumping bed plant rows, such as a row R, in a minimum tillage practice as best seen in FIG. 6.

Accordingly, it would be highly desirable to more precisely control or steer an implement 14 along a desired path of travel as it is pulled behind the tractor 12, taking into consideration its freedom to move from side to side, and more particularly, taking into consideration the degree of roll or tilt movement the implement may experience relative to the variable soil conditions encountered in open field conditions.

As will be described hereinafter in greater detail, the implement control system 10 includes a sensing arrangement to measure the deviation of the implement 14 relative to a desired path of travel, where the sensing arrangement of the implement control system 10 is no longer disposed on the ground. As a result of this unique configuration, roll motion of the implement 14 will now result in position measurement errors. That is, if “h” is the height of the sensing arrangement above the ground and “φ” is the roll angle of the implement 14, the GPS measurement from the sensing arrangement will have an error expressed as follows:

Error=h sin(φ) Equation 1

Some previous systems measured the position of the implement 14 utilizing a ground sensor, so no tilt compensation was required, since the sensor was co-located with the point of interest, that is, the contact point between the implement and the ground. Unlike previous GPS systems that actively control the position of an implement, such as the implement 14, the present GPS-based implement steering system measures the roll angle of the implement 14, and corrects the error caused by the fact that the GPS antenna is located significantly above the point of interest, by the distance “h”.

Therefore, if “y” is defined as the computed corrected measurement of the implement lateral position error, and “yₘ” is defined as the raw measurement of the implement lateral position error, then we have the following:

y=yₘ−h sin(φ) Equation 2

Based on the foregoing, it should be understood by those skilled in the art, that the navigation signal derived by the system is a position measurement in a defined space; wherein said defined space is not a furrow on ground. It should also be understood that the roll angle of the implement 14, can be estimated in a variety of ways as will be explained hereinafter in greater detail.

Considering now the implement control system 10 in greater detail with reference to FIG. 1, the control system 10 generally includes: (1) a primary vehicle GPS steering system 20; and a secondary vehicle or implement GPS steering system 28; which systems (20 and 28) cooperate together in a seamless manner to cause an implement, such as the implement 14, to be actively controlled and steered along a desired path of travel. In this preferred embodiment of the present invention, the deviation of the implement 14 relative to a desired path is determined by an indirect measurement of implement tilt.

In order to determine or measure the implement tilt indirectly, the implement control system 10 includes a vehicle orientation module or vehicle tilt and position sensing arrangement 30 which cooperates with at least one implement position sensor 90, such as an implement mounted GPS antenna. The vehicle orientation module 30 and the implement position sensor 90 provide measurement indications which enable the primary vehicle GPS steering system 20 and the implement GPS steering system 28 to work together to cause the implement 14 to travel along the desired path of travel. The desired path of travel followed by the implement 14 in this case, is a corrected path of travel that compensates for tilt of the implement 14 caused for example, by sloped terrain or variable soil conditions. Implement tilt compensation is an important feature and result of the present invention since the corrected path of travel facilitates improved accuracy in any given farming operation, whether it be planting, cultivating, fertilizing, or harvesting for example.

The advantage of such implement control is illustrated in FIG. 7, which is a comparison chart 200 that illustrates a desired path of travel 202, an uncorrected path of travel 204 followed by an implement 14 without correcting its path of travel for drift; and a corrected path of travel 206 with drift compensation when the implement 14 is operated and directed under the control of the implement control system 10.

Considering now the implement control system 10 in greater detail with reference to FIG. 1, it should be understood that the primary vehicle or tractor 12 follows a desired path of travel as determined by the primary vehicle GPS steering system 20. In this regard, the primary vehicle steering system 20 is a GPS-based system which generally includes a user terminal 40, a vehicle steering electronic module 50, which system 20 is coupled to the vehicle orientation module 30 via a CAN bus interface B, such as defined in an ISO-11783 or SAE-J1939 standard.

In order to process the measurement signals from the vehicle orientation module 30 and the implement position sensor 90, the user terminal 40 includes a vehicle control manager processor 42 and an implement control manager processor 82, which processors 42 and 82 respectively operate under the control of associated steering control algorithms 420 and 820, which algorithms 420 and 820 facilitate active steering of both the tractor 12 and the implement 14 along the desired path of travel.

The orientation module 30, which is sometimes called herein “a roof module” is adapted to be mounted to a roof portion 16 of the tractor 12, while the user terminal 40 is adapted to be mounted within the interior cab space of the tractor 12, as best seen in FIG. 3. The orientation module 30, facilitates the generating of GPS measurement signals such as vehicle position, vehicle roll, vehicle heading and implement position, which in turn helps facilitate the steering of the tractor 12 as it pulls or tows a selected implement component 14, such as a planting device, a cultivating device, a tillage device, or the like through an open field F.

As best seen in FIG. 1, the orientation module 30 includes a GPS-based vehicle tilt sensor 34A and a vehicle position sensor 36A, which sensors 34A and 36A are coupled to the user terminal or touch screen display 40 through the CAN bus interface B. The tilt sensor 34A is preferably an inertial sensor, such as an accelerometer or pendulum-based tilt sensor, or any one of a number of tilt sensors that are well know in the industry. For example, the tilt sensor 34A could be two or more GPS antennas which provide a measurement of the roll or tilt of the vehicle 12. It could also be an inertial sensor, such as a “gyro” that estimates roll or tilt angle by integrating and filtering tilt rate measurement, or it could also be any combination of the above-mentioned sensor configurations.

Considering now the user terminal 40 in greater detail with reference to FIG. 1, the user terminal 40 generally includes the micro-processor based vehicle control manager 42, which provides the user interface for the implement control system 10, which control manager 42 may also perform some of the GPS and/or steering control processing as will be described hereinafter in greater detail. For the moment, however, it will suffice to indicate that the vehicle steering control algorithm 420 runs on the micro-processor 42, which algorithm 420 incorporates the GPS measurements (vehicle position, vehicle roll, vehicle heading, and implement position provided by the orientation module 30) and generates steering actuator commands for utilization by the tractor 12. More specifically, the vehicle steering control algorithm 420 enables the tractor 12 to follow a desired path of travel, as defined by the user through the user terminal or touch screen display 40. The vehicle steering control algorithm 420, is well known in the prior art as previously mentioned relative to U.S. Pat. No. 6,865,465 and therefore, the vehicle steering control algorithm 420 will not be described hereinafter in greater detail.

As best seen in FIG. 1, the roof module 30 and the user interface 40 are also coupled to the vehicle steering electronic module 50 through the CAN bus interface B. The vehicle steering electronic module 50 is coupled to at least one steering actuator 52 which is disposed on the tractor 12 for the purpose of automatic tractor steering. In this regard, each steering actuator 52 is a proportional electro-hydraulic valve block that is teed into the hydraulic steering of the vehicle 12. The vehicle steering module 50 is also coupled to one or more front wheel sensors, such as a sensor 54 (such as a potentiometer), and a pressure transducer 56, which respectively measures the deflection angle of the front wheels and the turning pressure that a driver may be applying to turn the steering wheel (not shown) of the tractor 12. The vehicle steering electronic module 50 is designed to facilitate the interpretation of steering messages which appear on the CAN bus interface B, and to convert these messages into steering command signals, which are communicated to the electro hydraulic valve or steering actuators 52. The vehicle electronic module 50 also samples the pressure transducer 56, and generates additional measure information which is reported on the CAN bus interface B.

The vehicle steering electronic module 50 has a conventional construction which is well known by those skilled in the art. For example, refer to U.S. Pat. No. 6,052,647 entitled “Method and System for Automatic Control of Vehicles Based on Carrier Phase Differential GPS”, by Bradford W. Parkinson, et al which provides a detailed description of such a vehicle steering electronic module.

From the foregoing, it should be understood by those skilled in the art, that the primary vehicle GPS steering system 20 is designed to steer a wheeled farm vehicle, such as the tractor 12, along a desired path of travel within an open field under control of the vehicle steering control algorithm 420.

Considering now the secondary vehicle or implement steering system 28 in greater detail with reference to FIG. 1, the secondary vehicle steering system 28, which may be referred to hereinafter from time to time as “an active steering case”, includes an implement steering electronic module 60, which is coupled to an implement steering arrangement that includes an actuator, such as a hydraulic valve 64 for steering a steering coulter 62. The steering coulter 62, is disposed on the implement 14 for the purpose of correcting the drift or tilt deviation of the implement 14 caused by the terrain.

From the foregoing, it should be understood that the steering coulter 62 is a steerable metal disc that serves as an active steering mechanism of the implement 14. The coulter 62 is steered by the electro hydraulic valve 64. The angle of the coulter 62 is measured by a feedback sensor 65, such as a potentiometer. In this regard, the feedback sensor 65 provides the implement steering electronic module 60 with a positive feedback signal which is indicative of the coulter 62 having been turned or steered to a proper angle to achieve the necessary correction to compensate for the drift. Stated otherwise, the implement steering electronic module 60 is designed to facilitate the interpretation of steering messages which appear on the CAN bus interface B, and to convert these messages into steering command signals, which are communicated to the electro hydraulic valves 64.

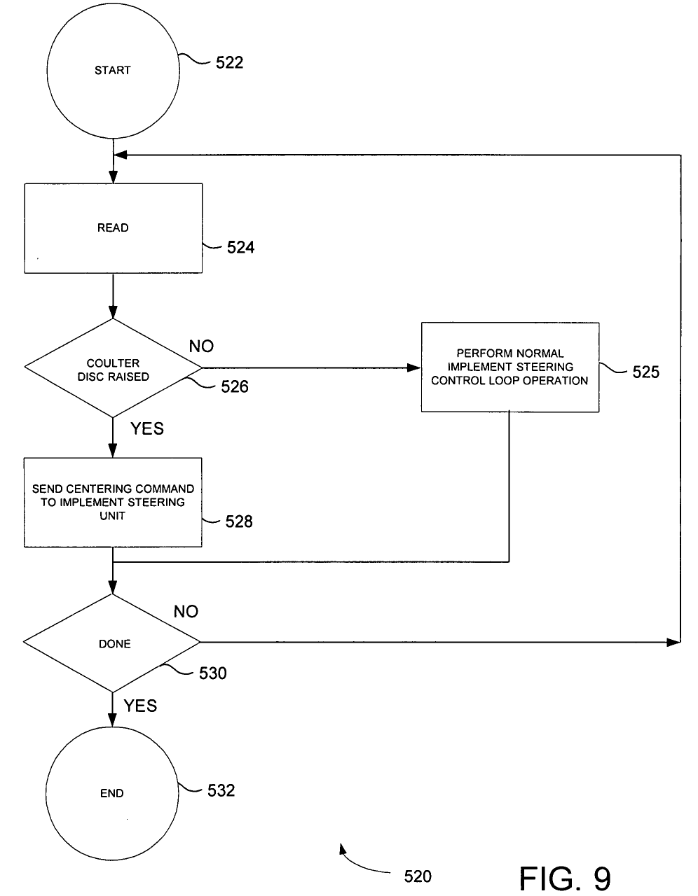

The implement steering electronic module 60 also samples a lift sensor 66 which detects whether the coulter discs 62 are in a raised or lower position relative to the ground. This is an important feature of the present invention because it assures that the GPS-based implement steering system 28 or more particularly, the coulter discs 62, are accurately aligned before insertion into the ground. This is important since if the coulter discs 62 are not centered a wiggle will occur at the beginning of each row when the implement tool is lowered into contacting engagement with the ground. Thus, by sensing when the coulter discs 62 are raised, the implement steering module 60 under the control of a coulter alignment algorithm 520 (FIG. 9), aligns the coulter angle to the path of the vehicle 12 or implement 14, so that no unwanted and undesired side-to-side movement occurs. Finally, it should be noted that the implement steering electronic module 60 also samples and generates additional measurement information which is reported on the CAN bus interface B. Such additional information, as will be explained hereinafter in greater detail, could be for example, the tilt orientation of the implement 14.

The implement steering electronic module 60 has a conventional construction which is well known by those skilled in the art. For example, such an implement steering electronic module is manufactured and sold by Novariant, Inc., located in Menlo Park, Calif. As well known to those skilled in the art and similar to the vehicle electronic module described earlier herein, the vehicle (or implement) electronic module typically consists of a microcontroller which receives digital commands via the CAN bus. The steering module includes a set of analog to digital converters (not shown) for sensing coulter angle sensors and lift switch values. Analog outputs to command the electro hydraulic valve 64 can be generated with digital-to-analog converters or power transistors. The electronic steering module 60 receives commands and publishes sensor data using digital messages over the CAN bus.

Considering now the coulter alignment algorithm 520 in greater detail with reference to FIG. 9, the coulter alignment algorithm begins with a start step 522, and then proceeds to a read command at step 524. The read command at step 524 allows the implement electronic steering module 60 to read the state of the implement lift switch or sensor 66. The algorithm 520 then advances to a determination step 526.

At step 526, a determination is made by the implement electronic steering module 60 as to whether the coulter discs 62 are raised or lowered into engagement with the ground. If the coulter discs 62 are not raised, the algorithm goes to a control command at step 525. Otherwise, the algorithm proceeds to a send command at step 528.

If the algorithm determined that the coulter discs 62 are not raised, the control command at step 525 enables the implement electronic steering module 60 to perform a normal implement steering control loop operation. When this operation has been completed, the algorithm proceeds to the send command at step 528.

Considering now the send command at step 528, when the send command is executed at step 528 by the implement electronic steering module 60, a centering command is sent to the implement steering unit. Next, the algorithm goes to a determination step 530 to make a determination of whether the coulter discs 62 have achieved a centered state. If the coulter discs 62 have reached a centered state, the algorithm goes to an end command at step 532. Otherwise the algorithm returns to the read command at step 524 and proceeds as previously described.

Based on the foregoing, it should be understood by those skilled in the art that the implement steering module 60 is adapted to incorporate signal measurements from the roof or orientation module 30, which provides an indication of the roll motion of the vehicle 12 and the implement 14 after a predetermined delay period, since the implement 14 follows behind the tractor. In this regard, the roll motion of the implement 14 results in certain position measurement errors which error measurements are utilized by the implement steering controller 60 to measure deviation of the path of travel followed by the implement 14 from a desired path of travel, such as the desired path of travel 202 as depicted in FIG. 7. The deviation signals are processed by the tracking microprocessor or implement control manager 82 which operates under the control of the implement steering control system algorithm 820. That is, the implement steering control algorithm 820 generates implement steering control command signals which are coupled to the implement steering actuator 64, that functions to change the angle of a steering mechanism 62. In this regard, the metal discs 62 act as rudders which functions as an active steering mechanism of the implement 14. The coulter of steerable metal disc or discs 62 are driven or steered through the electro hydraulic valve 64, and the angle of the coulter 62 relative to the implement 14 is measured utilizing the steering feedback sensor 65. Although in this preferred embodiment the actuator 64 is described as an electro hydraulic valve, other types of actuators can also be utilized; for example, a hydraulic ram.

Although in this preferred embodiment of the present invention, the processors 42 and 82 and their associated steering control software modules or algorithms 420 and 820 respectively are illustrated as being disposed in the user terminal 40, it should be understood by those skilled in the art that the processors and software modules may be disposed elsewhere within the system 10. For example, the processors and software modules could be located in the orientation module 30, in the vehicle steering electronic module 50, or in the implement steering electronic module 60 without departing from the true scope and spirit of the present invention.

Also, although in this preferred embodiment the user terminal 40 is described as having two processors 42 and 82 respectively, which operate under the control of two separate software modules 420 and 820 respectively, it should be understood by those skilled in the art, that a single processor and a single software module could be utilized to carry out the required control functions without departing from the true scope and spirit of the present invention.

Referring now to the drawings and more particularly to FIG. 12 thereof, there is illustrated an implement control system 110, which is constructed in accordance with another preferred embodiment of the present invention. The implement control system 110 compensates and corrects for unwanted and undesired implement drift caused by uneven soil conditions, side hills, planting beds, contours and other similar conditions, which help to reduce costs while improving yields by ensuring precise placement of inputs. The implement control system 110, like the implement control system 10 determines the deviation of the implement 14 relative to a desired path by an indirect measurement of implement tilt.

Considering now the implement control system 110 in greater detail, the implement control or steering system 110 is substantially similar to the implement control system 10, which includes a vehicle or tractor GPS steering system 20 and an implement steering system 28. Like the implement control system 10, the tractor steering system 20 and the implement steering system 28 are each coupled to a roll measurement arrangement via a CAN interface bus B. The roll measurement arrangement in this preferred embodiment however is a GPS arrangement wherein GPS-based devices are utilized to measure all three parameters—the vehicle position, the vehicle tilt, and the implement position. In this regard, the implement control system 110 includes a vehicle orientation module 30A having a set of dual frequency GPS antennas 34 and 36 respectively, and a GPS receiver 38, which functions as a position sensor for the vehicle 12. The GPS receiver 38 is also coupled to an implement position GPS antenna 90. The vehicle orientation module 30A and the implement GPS antenna 90 provide measurement indications which enable the primary vehicle GPS steering system 20 and the implement GPS steering system 28 to work together to cause the implement 14 to travel along the desired path of travel.

As implement control system 110 is otherwise substantially the same as the implement control system 10, the implement control system 110 will not be described hereinafter in greater detail. However, it should be understood by those skilled in the art that the GPS antennas 34, 36 and 90 may also be described as radio location antennas for tracking navigation signals, wherein the navigation signals are derived from one or more navigation satellites including one of GPS, GLONASS, and Galileo. Further, it should be understood that a radio location antenna is able to track signals from ground-based navigation transmitters (not shown), such as pseudolites, and Terralites.

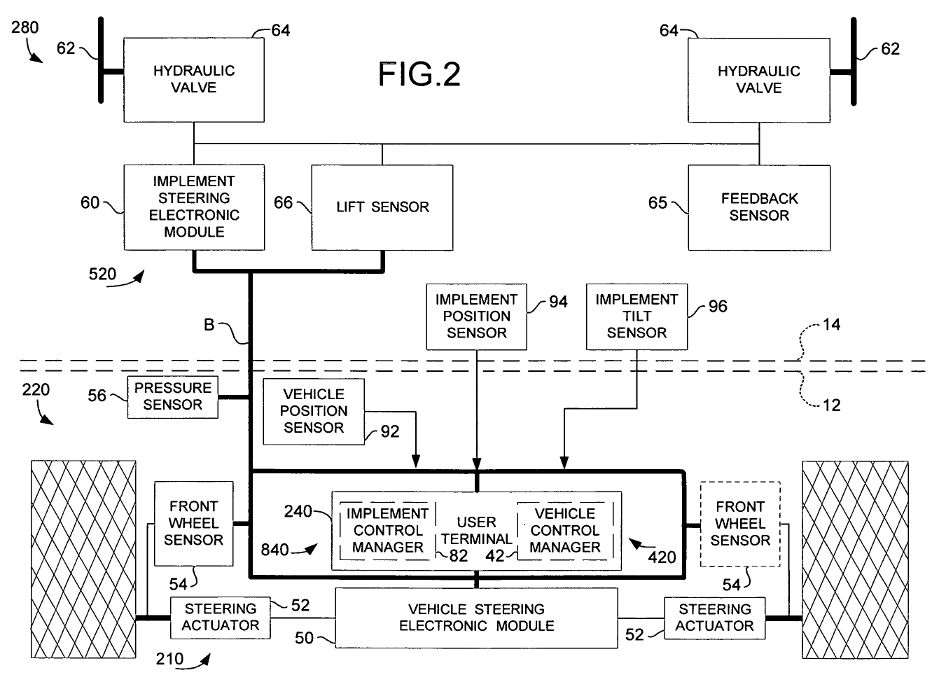

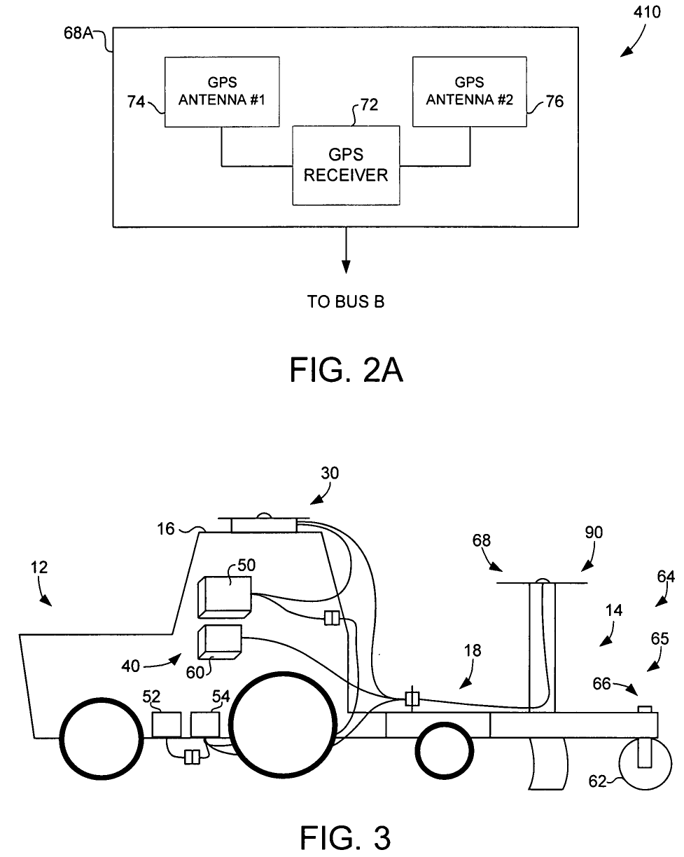

Referring now to the drawings and more particularly to FIG. 2 thereof, there is illustrated yet another implement control system 210, which is constructed in accordance with another preferred embodiment of the present invention. The implement control system 210 compensates and corrects for unwanted and undesired implement drift caused by uneven soil conditions, side hills, planting beds, contours and other similar conditions. The implement control or steering system 210, unlike the implement control systems 10 and 110 as described herein earlier, determines the deviation of the implement 14 relative to a desired path by a direct measurement of implement tilt as will be explained hereinafter in greater detail.

Considering now the implement control system 210 in greater detail, the implement control or steering system 210 is substantially similar to the implement steering control system 10, which includes a vehicle or tractor steering system 220 and an implement steering system 280. Like the implement control system 10, the tractor steering system 220 and the implement steering system 280 are each coupled to a roll measurement arrangement via a CAN interface bus B. The roll measurement arrangement in this preferred embodiment however, allows for the direct measurement of implement tilt and includes a vehicle position sensor 92, an implement position sensor 94 and an implement tilt sensor 96. The roll measurement arrangement sensors 92, 94, and 96 are each coupled to a user terminal 240 via the CAN interface bus B. The vehicle position sensor 92 and the implement sensors 94 and 96 respectively, provide measurement indications which enable the primary vehicle steering system 220 and the implement steering system 280 to work together to cause the implement 14 to travel along the desired path of travel. It should be understood however, since the system 210 is measuring the tilt of the implement 14 directly, there is no need to provide a time delay as was required for the indirect measurement systems 10 and 110 respectively.

Considering now the implement tilt sensor 96 in greater detail, the implement tilt sensor 96 provides an indication of the roll motion of the implement 14. The tilt sensor 96 is preferably an inertial sensor, such as an accelerometer or pendulum-based tilt sensor, or any one of a number of tilt sensors that are well known in the industry. For example, the tilt sensor 96 could be two or more GPS antennas which provide a measurement of the roll or tilt of the implement 14. It could also be an inertial sensor, such as a “gyro” that estimates roll or tilt angle by integrating and filtering tilt rate measurement, or it could also be any combination of the above-mentioned sensor configurations.

Considering now the implement steering system 280 in greater detail, the implement steering system 280 tracks deviation of the path of travel followed by the implement 14 relative to a desired path of travel, where the deviation is computed by the implement control manager 82 and its associated implement steering control algorithm 840. In this case however, the implement steering control algorithm 840 utilizes information provided by the implement tilt sensor 96 which provides a direct indication of the roll motion of the implement 14.

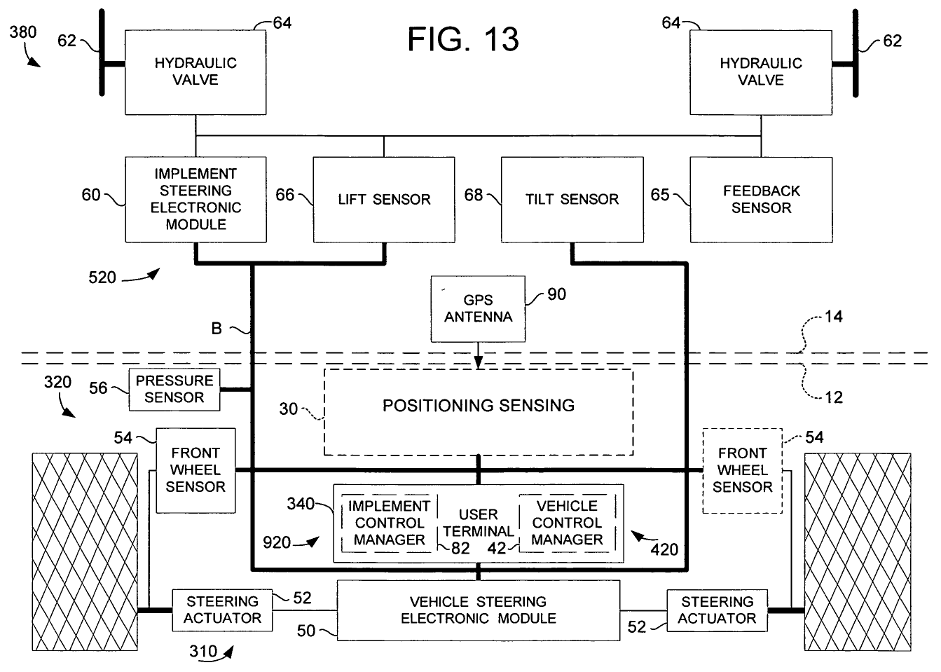

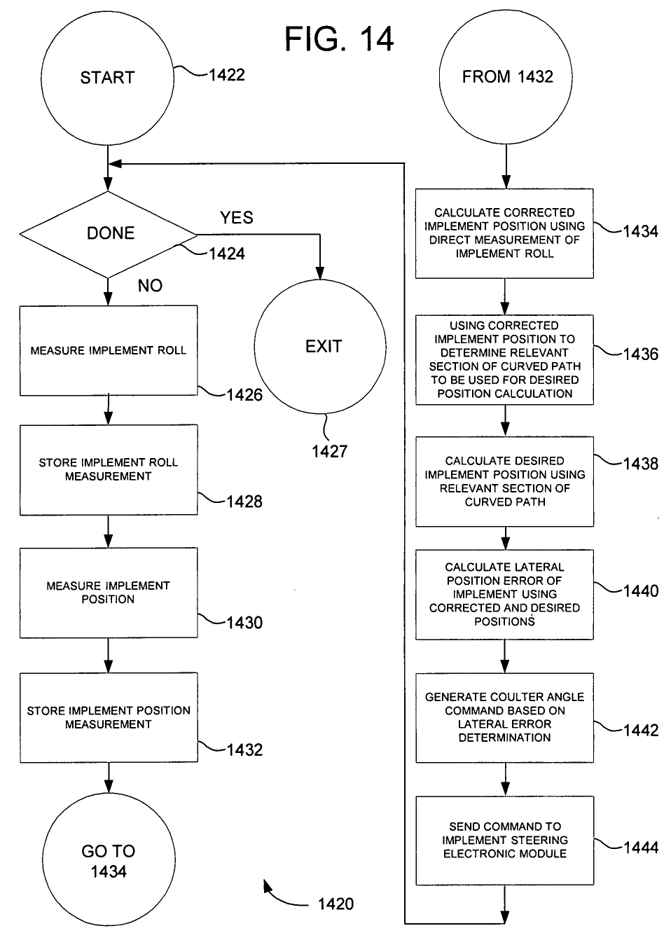

Referring now to the drawings and more particularly to FIG. 13 thereof, there is illustrated yet another implement control system 310, which is constructed in accordance with another preferred embodiment of the present invention. The implement control system 310 compensates and corrects for unwanted and undesired implement drift caused by uneven soil conditions, side hills, planting beds, contours and other similar conditions. The implement control or steering system 310, like the implement control systems 210 as described herein earlier, determines the deviation of the implement 14 relative to a desired path by a direct measurement of implement tilt as will be explained hereinafter in greater detail.

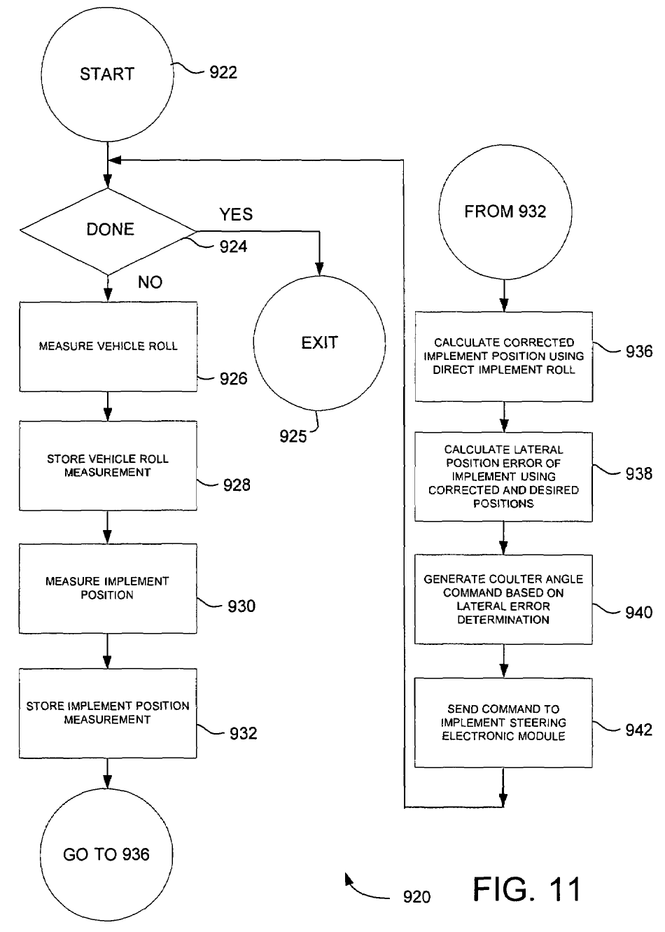

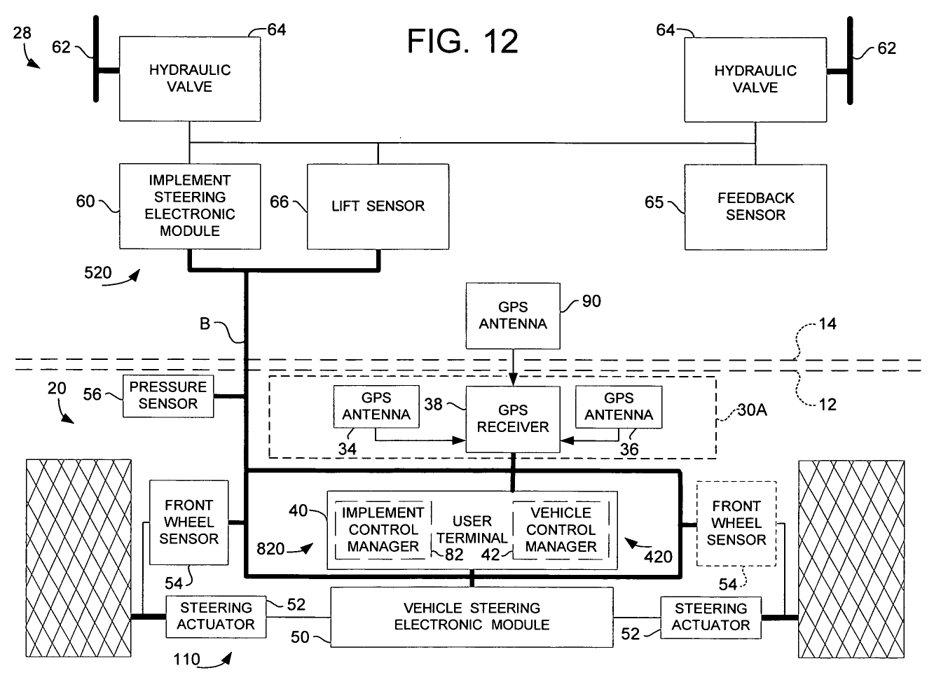

Considering now the implement control system 310 in greater detail, the implement control or steering system 310 is substantially similar to the implement steering control system 210, which includes a vehicle or tractor steering system 320 and an implement steering system 380. Like the implement control system 210, the tractor steering system 320 and the implement steering system 380 are each coupled to a roll measurement arrangement via a CAN interface bus B. The roll measurement arrangement in this preferred embodiment allows for the direct measurement of implement tilt and includes a vehicle positioning sensing module 30, an implement position sensor or GPS antenna 90 and an implement tilt sensor or accelerometer 68. The vehicle positioning sensing module 30, the implement GPS antenna 90 and an accelerometer 68 are each coupled to a user terminal 340 via the CAN interface bus B. The user terminal 340 includes an implement control manager or microprocessor 82 that operates under the control of an implement control algorithm 920. The implement control algorithm 920 will be described hereinafter in greater detail with reference to FIGS. 11 and 13.

The vehicle positioning sensing module 30 and the implement sensors 68 and 90 provide measurement indications which enable the primary vehicle steering system 320 and the implement steering system 380 to work together to cause the implement 14 to travel along the desired path of travel. Since system 310 is measuring the tilt of the implement 14 directly, there is no need to provide a time delay as was required for the indirect measurement systems 10 and 110 respectively.

In still yet another preferred embodiment of the present invention, an implement control system 410, as best seen in FIG. 2A, is provided with an implement steering algorithm 8260 which accepts measurement signals from the tractor 12 and measurement signals from the implement 14 to compute two lateral displacements. In this regard, one lateral displacement is for the tractor 12 and the other lateral displacement is for the implement 14. The implement lateral displacement measurements are derived from an implement tilt sensor 68A which includes a set of dual frequency GPS antennas 74 and 76, where the GPS antennas 74 and 76 as best seen in FIG. 2A are utilized in place of the accelerometer measurement signals as previously described. For the tractor lateral displacement, as best seen in FIG. 2A, the implement control system 410 utilizes a tilt and positioning sensor 30A in the form of another set of dual frequency GPS antennas 34 and 36 and GPS receiver 38 mounted to the tractor 12. In short then, the vehicle control manager 42 under the control of the vehicle steering algorithm 420 is utilized with the tractor or primary vehicle GPS steering system 20 to steer the tractor 12 along a curved path, while the implement lateral displacement measurement is provided to the implement control manager 82 under the control of the implement steering algorithm 820 is utilized with the implement and implement steering module 60 to actively steered the implement 14 along the curved path. In short, the tractor 12 is driven along a desired curved path and the implement 14 is driven along the same desired curved path.

Based on the foregoing, it should be understood by those skilled in the art that the roll angle of the implement 14, can be estimated in a variety of ways. For example, the tilt sensor 68 can be an accelerometer or as best seen in FIG. 2A, a set of multiple dual frequency GPS antennas, such as GPS antennas 74 and 76 as best seen in FIG. 2A. It should also be understood by those skilled in the art, that the tilt sensor can be mounted to the vehicle 12 for indirect measurement using a time delay tactic, or to the implement 14 for direct measurement of implement tilt without need of using a time delay tactic. Moreover it should be understood that the tilt sensor can be mounted to either the vehicle 12 or the implement 14 at any desired distance “h” above ground level.

Considering now the implement control system 110 in still greater detail, in order to take advantage of the fact that the implement 14 is going over the same terrain as the tractor 12 the orientation module 30A, which is mounted to the tractor 12, may include a tilt sensor, such as an accelerometer 38 instead of the position sensor 32. In yet another embodiment, the tilt sensor could be implemented as a set of dual frequency GPS antennas indicated generally at 34 and 36 respectively. Such tilt sensors would be able to measure the slope of the terrain at a particular location, and this slope could then be applied to the implement 14 when it reaches the same location as the tractor 12, but only a short time later since the implement 14 is being pulled by the tractor 12 across the same terrain. In order to determine the position of the implement 14 relative to the tractor 12, the implement control system 110 also includes the GPS antenna 90, which is mounted on the implement 14.

In this embodiment, the roll compensation is to take the roll measurement of the tractor 12 using the GPS antenna 90 and the accelerometer 38 measurement signals, and then applying a time delay to the implement position measurement in order to assume that the vehicle roll measurement applies to the implement 14. In this preferred embodiment, the time delay is equal to the nominal longitudinal distance between the tilt sensors on the tractor 12 and the GPS antenna on the implement 14 divided by the speed of the vehicle. For example, if the antennas are nominally separated by a distance of 5 meters for example, and the tractor 12 is moving at 2.5 meters per second, then a 2-second delay is applied to the roll measurement of the tractor 12 to estimate the roll measurement of the implement 14.

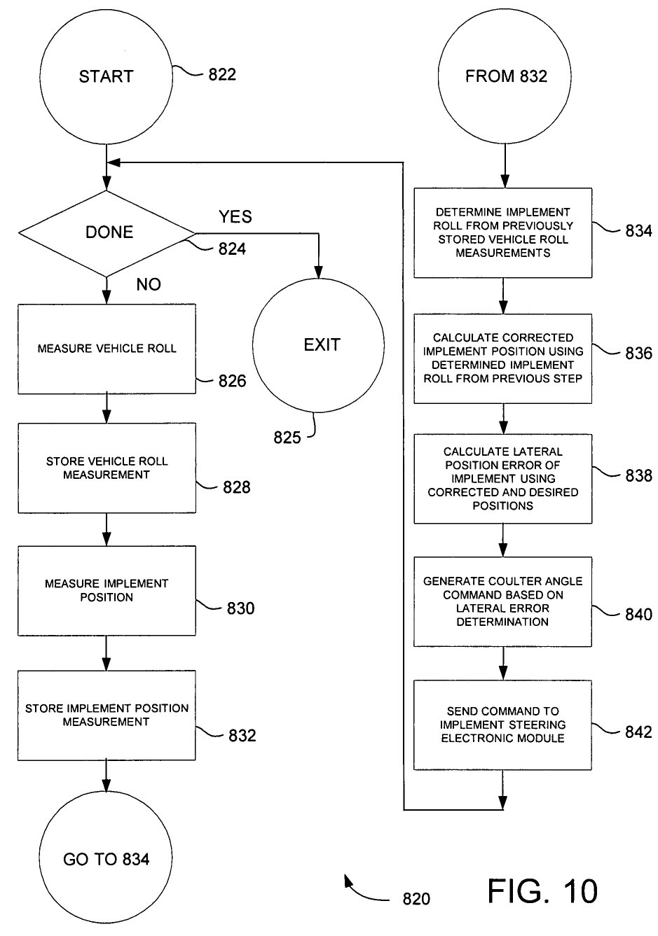

Considering now the implement steering control algorithm 820 in greater detail with reference to FIG. 10, the implement steering control algorithm 820 with indirect implement tilt measurements begins with a start step 822 and proceeds to a determination command at step 824. The determination command at step 824 allows the control algorithm 820 to repeat each of its steps, that will be described hereinafter in greater detail, until the system is deactivated. In this regard, if the system is deactivated, the algorithm goes to an exit command 825 and stops. Otherwise, the algorithm proceeds from the determination step 824 to a measure command at step 826.

The measure command at step 826 causes the output from the vehicle tilt sensor, such as the vehicle tilt sensor 34A to be sampled by the user terminal 40. After the output from the vehicle tilt sensor 34A has been sampled, the control algorithm 820 advances to a store command at step 828 which causes the user terminal 40 to store the vehicle roll measurement that was just sampled. Next the control algorithm 820 proceeds to another measure command at step 830.

The measure command at step 830 causes the output from the implement position sensor, such as the implement position sensor 90, to be sampled by the user terminal 40. After the output from the implement position sensor 90 has been sampled, the control algorithm 820 goes to another store command 832 which causes the user terminal 40 to store the implement position measurement that was just sampled. Next, the control algorithm advances to a determine command at step 834.

The command at step 834 determines the implement roll utilizing the previously stored vehicle roll measurement. Once the implement roll from the previously stored vehicle roll measurements has been determined, the control algorithm 820 proceeds to a calculate command at a step 836. It should be noted that if there is no previous stored vehicle roll measurement, the implement roll will be assumed by the algorithm to be equal to the vehicle roll measurement until such time that an appropriate stored vehicle value is available. Alternately, the implement roll may be assured by the algorithm to be level or zero until the vehicle roll is available.

The calculate command 836 causes the microprocessor 82 to calculate a corrected implement position utilizing the determined implement roll acquired in step 834. After calculating the implement position, the control algorithm goes to another calculate command at a step 838.

The calculate command 838 causes the microprocessor 82 to calculate a lateral position error for the implement 14. That is, using the corrected implement position from step 836 and a desired position, the microprocessor 82 calculates the lateral position error for the implement 14. The control algorithm then advances to generate a steering control command at step 840.

The command at step 840 generates a coulter angle command based on the lateral error determination acquired at step 838. As known by those skilled in the art, a PID (proportional integral derivative) algorithm for example could be used to calculate the coulter angle command. The generated coulter angle command is then communicated to the implement steering electronic module 60. More particularly, the control algorithm 820 proceeds to a send communication command at step 842. Once the communication command at step 842 has been executed, the control algorithm returns to the determination step 824, where the control algorithm proceeds as previously described.

Considering now the implement steering control algorithm 920 in greater detail with reference to FIG. 11, the implement steering control algorithm 920 with direct implement tilt measurements begins with a start step 922 and proceeds to a determination command at step 924. The determination command at step 924 allows the control algorithm 920 to repeat each of its steps, that will be described hereinafter in greater detail, until the system is deactivated. In this regard, if the system is deactivated the algorithm goes to an exit command at step 925 and stops. Otherwise, the algorithm proceeds from the determination step 924 to a measure command at step 926.

The measure command at step 926 causes the output from the implement tilt sensor, such as the implement tilt sensor 96 to be sampled by the user terminal 340. After the output from the implement tilt sensor 96 has been sampled the control algorithm 920 advances to a store command at step 928 which causes the user terminal 340 to store the implement roll measurement that was just sampled. Next the control algorithm 920 proceeds to another measure command at step 930.

The measure command at step 930 causes the output from the implement position sensor, such as the implement position sensor 94, to be sampled by the user terminal 340. After the output from the implement position sensor 94 has been sampled, the control algorithm 920 goes to another store command 932 which causes the user terminal 340 to store the implement position measurement that was just sampled. Next the control algorithm advances to a calculate command at a step 936.

The calculate command 936 causes the microprocessor 820 to calculate a corrected implement position utilizing the implement roll measurement acquired at step 926. After calculating the corrected implement position at step 936, the control algorithm goes to another calculate command at a step 938.

The calculate command 938 causes the microprocessor 820 to calculate a lateral position error for the implement 14. That is, using the corrected implement position from step 936 and a desired position, the microprocessor 820 calculates the lateral position error for the implement 14. The control algorithm then advances to step 940 which causes the microprocessor 820 to generate a coulter angle command based on the lateral position error calculated at step 938.

The command at step 940 generates a coulter angle command based on the lateral error determination acquired at step 938. As known by those skilled in the art, a PID (proportional integral derivative) algorithm, for example, could be used to calculate the coulter angle command. The generated coulter angle command is then communicated to the implement steering electronic module 60. More particularly, the control algorithm 920 proceeds to a send communication command at step 942. Once the communication command at step 942 has been executed, the control algorithm returns to the determination step 924, where the control algorithm proceeds as previously described.

Whenever a curved path situation occurs, a modified steering control algorithm 1420 is activated instead of the steering control algorithm 920. Considering now the modified implement steering control algorithm 1420 in greater detail with reference to FIG. 14, the modified implement steering control algorithm 1420 begins with a start command at step 1422. Next the algorithm proceeds to a determination command at step 1424.

The determination command at step 1424 allows the control algorithm 1420 to repeat each of its steps, that will be described hereinafter in greater detail, until the system is deactivated. In this regard, if the system is deactivated the algorithm goes to an exit command at step 1427 and stops. Otherwise the algorithm proceeds from the determination step 1424 to a measure command at step 1426.

The measure command at step 1426 causes the output from the implement tilt sensor, such as the implement tilt sensor 68, to be sampled by the user terminal 340. After the output from the implement tilt sensor 68 has been sampled, the control algorithm 1420 advances to a store command at step 1428 which causes the user terminal 340 to store the implement roll measurement that was just sampled. Next, the control algorithm 1420 proceeds to another measure command at step 1430.

The measure command at step 1430 causes the output from the implement position sensor, such as the implement position sensor 90, to be sampled by the user terminal 340. After the output from the implement position sensor 90 has been sampled, the control algorithm 1420 goes to another store command 1432 which causes the user terminal 340 to store the implement position measurement that was just sampled. Next the control algorithm advances to a calculate command at step 1434.

The calculate command at step 1434 causes the user terminal to calculate a corrected implement position utilizing the direct measurement of implement roll that was stored at step 1428. The algorithm then proceeds to determination step at 1436 to determine a relevant section of the curved path to be used for a desired position calculation by using the corrected implement position.

Next, the algorithm advances to another calculate command at step 1438. The algorithm at step 1438 calculates the desired implement position utilizing the relevant section of the curved path calculated in the previous step.

The algorithm then goes to another calculate command at step 1440. The algorithm at step 1440, calculates the lateral position error of the implement 14 using the corrected and desired positions.

From step 1440, the algorithm advances to a command step 1442, which generates a coulter angle command based on the lateral error determination. The algorithm then proceeds to a send command at step 1444. At step 1444, the algorithm causes a send command to be sent to the implement electronic steering module 60. From step 1444, the algorithm returns to the decision step 1424, where the algorithm proceeds as previously described.

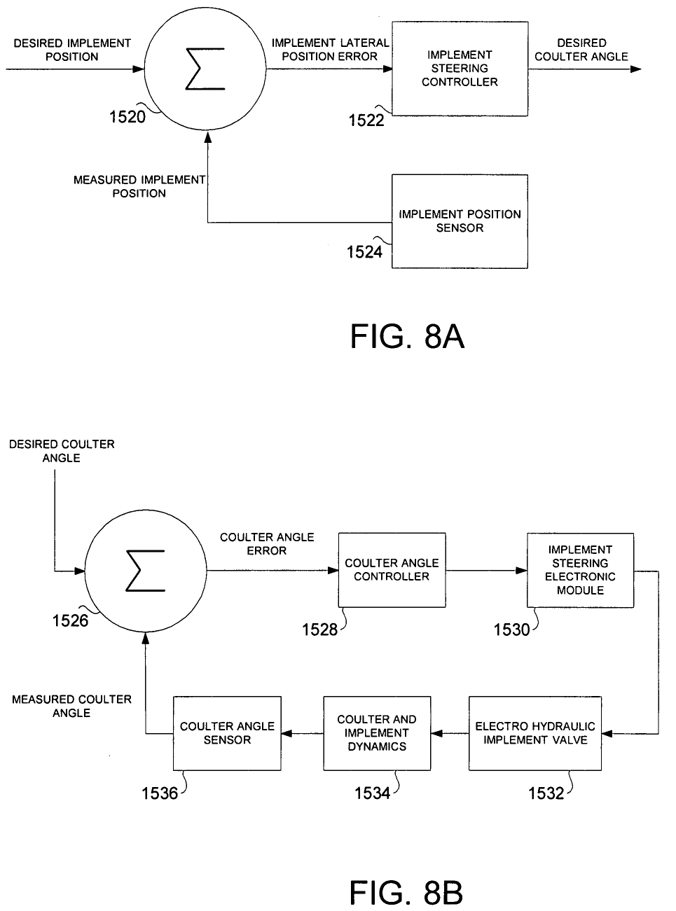

Referring now to FIGS. 8A and 8B, the method of causing the implement 14 to follow a curved path is considered in still greater detail. The curved path that the implement 14 is to follow is controlled by setting the coulter discs 62 at a desired angle so the implement 14 follows a desired path of travel. Now, referring to FIG. 8A, it can be seen that at a summing step 1520, the sum of the measurement signals indicative of the implement position as measured by the implement position sensor at step 1524, and a desired implement position as determined, for example, by a path previously followed by the vehicle 12, provides an implement lateral position error indication. This implement lateral position error is utilized by the implement steering controller or implement electronic steering module 60 at a determination step 1522 to determine a desired coulter angle.

Referring now to FIG. 8B, it can be seen that the desired coulter angle is summed at a summing step 1526 with a measured coulter angle signal obtained at a sampling step 1536. The sum output, is a coulter angle error which is provided to the implement control manager at step 1528. The sum output is processed and then sent to the implement steering electronic module 60. At a step 1532, the electro hydraulic implement valve 64 responses to the implement steering electronic module 609, which at step 1534 effects a coulter and implement dynamic response. At a step 1536, the coulter angle sensor 65 provides a signal indicative of the position of the coulter discs 62, which signal is a measured coulter disc angle that is coupled to the summer at step 1526.

As best seen in FIG. 3, the primary vehicle or tractor 12 and the implement 14 are coupled together by an attachment 18. The attachment 18 in this case can be any convenient attachment, such as a semi-rigid hitch, in the form of a 3-point hitch or a rotatable connection, such as a drawbar. Since the tractor 12 and implement 14 are coupled together they will follow along a path of travel either under the control of the primary vehicle steering system 20 or the implement steering system 28 as will be described hereinafter in greater detail.

Considering now the method of actively steering the implement 14 in an open field under various terrain conditions, the implement control system 10 provides a first signal which is indicative of the roll of the tractor 12 and a second signal which is indicative of the position of the implement 14. These signals are processed by the user terminal 40, which in turn generates steering control or command signals which are indicative of the position of one or more points of interest on the implement 14 as it travels through an open field F. More particularly, the vehicle steering electronic module 50 and the implement steering electronic module 60 respond to the command signals by causing their respective actuators 52 and 64 to drive the tractor 12 and the implement 14 along a desired path of travel. In this regard, in one case, the desired path of travel followed by the tractor 12 corresponds to a first path followed by the tractor as it travels through the open field F. In another case, the path of travel followed by the tractor 12 is driven manually by a driver for some portion of the first path. In still yet another case, the path of travel followed by the tractor 12 is driven automatically by the vehicle steering control system 20 for at least some portion of the first path of travel. In another situation, the tractor 12 is driven manually by the driver for some portion of a subsequent pass through the open field F. In still yet another situation, the tractor 12 is driven automatically the vehicle steering control system 20 for some portion of a subsequent pass through the open field F.

Based on the foregoing, it should be understood by those skilled in the art, that the implement 14 responds to the implement steering control commands which causes the implement 14 to follow a desired path of travel. In some situations, the desired path of travel is defined relative to real time measurements of a path of travel followed by the tractor 12. In this regard, the path of travel followed by the implement 14 is actively controlled to match a desired path of travel in real time. In other situations, the path of travel followed by the implement 14 is first generated without driving through an open field F and then the path of travel followed by the implement 14 is actively controlled to match a desired path of travel through the open field F.

It should also be understood that in accordance with the implement steering control method that the tractor 12 is steered manually by a driver for some portion of the path followed by the tractor 12 as it travels through an open field F. In other situations, in accordance with the implement steering control method, the tractor 12 is steered automatically by the primary vehicle steering system 20 for some portion of the path followed by the tractor 12 as it travels through the open field F. In summary then, in some situations, the tractor 12 is actively steered to follow the same path of travel as the implement 14. In other situations, the tractor is actively steered to follow a different desired path of travel than that of the implement 14. In all situations, however, the method assures that the path of travel followed by the implement is roll compensated based upon the orientation of the implement, especially, the roll of implement to allow the “working part” of the implement which engages the ground to be accurately controlled.

While particular embodiments of the present invention has been disclosed, it is to be understood that various different modifications are possible and are contemplated within the true spirit and scope of the appended claims. For example, as described herein the implement control system 10 can be implemented in two general ways either with indirect measurement of implement tilt or with direct measurement of implement tilt. In the various implementations of the present invention, various position sensors and tilt sensor have been described. For example, a tilt sensor can be two GPS antennas as in one preferred embodiment, or as shown in other preferred embodiments an accelerometer, a pendulum-based tilt sensor, or even a tilt rate sensor such as a gyro. As still yet another example, at least one of the sensors could be an optical measurement device, such as a laser sensor.

As still yet another example, as best seen in FIG. 2, the invention is implemented with a vehicle position sensor disposed on the vehicle 12, and an implement tilt sensor disposed on the implement 14. The vehicle position sensor in this example can be an optical measuring device, or a laser sensor, such as a total station or Millimeter GPS from TopCon. Also, in this case, the implement tilt sensor can be, for example, an accelerometer as in the preferred embodiment, or other sensing arrangements such as two GPS antennas, a pendulum-based tilt sensor, or even a tilt rate sensor such as a gyro. In this example, since the tilt of the implement is being directly measured, the “time delay” tactic previously discussed is not required.

As yet another example, a simplified embodiment of the present invention is a vehicle and implement combination with a GPS sensor on the implement, a roll angle sensor on the vehicle or the implement, an actuator on the implement to actively steer the implement, and a processor which (1) applies a roll correction to the GPS measurement and (2) generates a control indication or command to the implement steering actuator. This embodiment does not require active steering of the vehicle. The vehicle could be steered by a person in the usual manner. The vehicle could also be steered by a person using a visual guidance display such as a GPS-based lightbar. The vehicle could also be automatically steered, but with a system accuracy that is not based on RTK-GPS, but rather on a less accurate GPS signal. This is an implement steering system capable of active roll compensation which is unique and novel. Based on the foregoing, there is no intention, therefore, of limitations to the exact abstract or disclosure herein presented.

We claim:

1. An implement steering system, comprising:
tilt means for providing an indication of tilt;
position detection means for providing an indication of the current position of said implement;
processor means for providing an implement drift correction signal in response to said indication of tilt and said indication of current position; and
implement drift correction means mounted to said implement and responsive to said drift correction signal for correcting the implement path of travel to correspond to said desired path of travel.

2. A method for implement steering, comprising the steps of:
providing an indication of tilt associated with an implement as it traverses along an implement path of travel;
providing an indication of the current position of said implement;
providing an implement drift correction signal in response to said indication of tilt and said indication of the current position; and
responding to said drift correction signal by correcting the implement path of travel to correspond to said desired path of travel.

3. An implement control system for controlling drift, comprising:
a plurality of sensors mounted to a primary vehicle and an implement;
wherein at least one sensor of said plurality of sensors provides an indication of primary vehicle tilt or implement tilt at any given point of time;
wherein at least another sensor of said plurality of sensors provides an indication of a current implement position;
a processor coupled to said plurality of sensors for providing a signal indicative of implement position and tilt at a given point of time relative to said primary vehicle; and
an active steering case mounted to said implement and responsive to said signal indicative of implement position and tilt.

4. The implement control system according to claim 3, wherein an individual one of said plurality of sensors is a radio location antenna for tracking navigation signals.

5. The steering control system, according to claim 4, wherein the navigation signals are signals from one or more navigation satellites.

6. The implement control system according to claim 4, wherein said desired path of travel is a curved path of travel through said open field.

7. The steering control system according to claim 4, wherein the navigation signals are signals from ground-based navigation transmitters.

8. The steering control system according to claim 10, wherein at least one of said a plurality of sensors is an optical measurement device.

9. The steering control system according to claim 8, wherein said optical measurement device is a laser sensor.

10. A steering control system, comprising:
an orientation sensor for measuring roll, said orientation sensor being mounted relative to an implement pulling vehicle or an associated implement;
a position sensor mounted on said implement for providing an indication of a current implement position; and
a processor coupled to said orientation sensor and to said positioning sensor for providing a steering control signal, wherein said steering control signal is indicative of the position of one or more points of interest on the implement other than the location of the positioning sensor.

11. The steering control system according to claim 10, further comprising:
an implement steering control system responsive to said steering control signal for causing a plurality of coulters coupled to said implement to steer said implement along a path of travel followed by said implement pulling vehicle.

12. The steering control system, according to claim 11, wherein said plurality of coulters have a sufficient leverage to accurately correct the position of said implement so that said implement follows the same path of travel as said implement pulling vehicle.

13. The steering control system according to claim 10, wherein said orientation sensor is mounted on said implement.

14. The steering control system according to claim 10, wherein said orientation sensor is mounted on said implement pulling vehicle.

15. The steering control system according to claim 10, wherein said implement pulling vehicle and said associated implement are coupled together by an attachment.

16. The steering control system, according to claim 15, wherein said attachment is a semi-rigid hitch.

17. The steering control system, according to claim 15, wherein said semi-rigid hitch is a 3-point hitch.

18. The steering control system, according to claim 15, wherein said attachment is a rotatable connection.

19. The steering control system, according to claim 15, wherein said rotatable connection is a drawbar.

20. The steering control system, according to claim 10, wherein said implement pulling vehicle is a tractor.

21. The steering control system according to claim 10, wherein said implement is selected from a group of implements including: a planting device, a cultivating device, and a tillage device.

22. The steering control system according to claim 10, wherein said positioning sensor is a radio location antenna for tracking navigation signals.

23. The steering control system according to claim 22, wherein the navigation signals are signals from one or more navigation satellites.

24. The steering control system according to claim 23, wherein the one or more navigation satellites include: GPS satellites, GLONASS satellites, and Galileo.

25. The steering control system according to claim 22, wherein the navigation signals are signals from ground-based navigation transmitters.

26. The steering control system according to claim 10, wherein said positioning sensor is an optical measurement device.

27. The steering control system according to claim 26, wherein said optical measurement device is a laser sensor.

28. The steering control system according to claim 10, further comprising an active steering case for facilitating the steering of said implement; and
wherein said active steering case is coupled to at least one actuator.

29. The steering control system according to claim 28, wherein said actuator is a coulter disc.

30. The steering control system according to claim 28, wherein said actuator is a hydraulic ram.

31. The steering control system according to claim 10, wherein said implement pulling vehicle is a tractor having an automatic steering system.

32. The steering control system according to claim 31, wherein said automatic steering system is responsive to said vehicle steering control signal for causing a set of wheels coupled to said tractor to steer said implement pulling vehicle along a desired path of travel.

33. The steering control system, according to claim 31, further comprising:
an implement steering control system responsive to said steering control signal for causing said implement to follow a desired path of travel.

34. The steering control system according to claim 32, wherein said desired path of travel is recorded using said positioning sensor during a first pass through an open field having variable soil conditions.

35. The steering control system according to claim 34, wherein the path of travel followed by said implement through said open field is actively controlled to correspond to the recorded first pass on one or more subsequent passes through said open field.

36. An implement steering control method, comprising the steps of:
providing a navigation signal indicative of an implement position, wherein said implement position is relative to a curved path in an open field; and
providing a steering control signal in response to said navigation signal, wherein said steering control signal is indicative of the position of one or more points of interest on an implement coupled to said implement pulling vehicle.

37. The implement steering control method according to claim 36, further comprising:
responding to said steering control signal for causing one or more actuators coupled to said implement to steer said implement along a desired path of travel.

38. The implement steering control method according to claim 37, wherein said desired path of travel corresponds to the path of travel followed by said implement pulling vehicle.

39. The implement steering control method according to claim 37, wherein said desired path of travel is a recorded path of travel.

40. The implement steering control method according to claim 39, wherein said recorded path of travel was recorded using said another signal indicative of an implement position during a first path through an open field having various soil conditions.

41. The implement steering control method according to claim 37, wherein said desired path of travel is actively controlled to correspond to a first path of travel followed by said implement pulling vehicle during a first pass through an open field having various soil conditions.

42. An implement steering control method, comprising the steps of:
providing a signal indicative of the roll of an implement pulling vehicle;
providing another signal indicative of an implement position; and
providing a steering control signal in response to the first two mentioned signals, wherein said steering control signal is indicative of the position of one or more points of interest on an implement as it travels through said open field having various soil conditions.

43. The implement steering control method according to claim 42, further comprising:
responding to said steering control signal for causing a plurality of actuators coupled to said implement to steer said implement along a desired path of travel.

44. The implement steering control method according to claim 43, wherein said desired path of travel corresponds to a first path followed by said implement pulling vehicle as it traveled though said open field having various soil conditions.

45. The implement steering control method according to claim 44, wherein said implement pulling vehicle is driven manually by a driver for some portion of said first path.

46. The implement steering control method according to claim 44, wherein said implement pulling vehicle is driven automatically by a steering control system for some portion of said first path.

47. The implement steering control method according to claim 45, wherein said implement pulling vehicle is driven manually by a driver for some portion of a subsequent pass through said open field.

48. The implement steering control method according to claim 45, wherein said implement pulling vehicle is driven automatically by a steering control system for some portion of a subsequent pass through said open field.

49. The implement steering control method according to claim 42, further comprising:
responding to said steering control signal for causing said implement to follow a desired path of travel.

50. The implement steering control method according to claim 49, wherein real time measurements of a path of travel followed by said implement pulling vehicle are utilized to define a desired path of travel for said implement; and
wherein the path of travel followed by said implement is actively controlled to match a desired path in real time.

51. The implement steering control method according to claim 50, wherein the path of travel followed by said implement is first generated without driving through said open field, and then the path of travel followed by the implement is actively controlled to match the desired path of travel through the field.

52. The implement steering control method according to claim 49, wherein the implement pulling vehicle, is steered manually by a driver for some portion of the path followed by the implement pulling vehicle as it travels through said open field.

53. The implement steering control method according to claim 49, wherein the implement pulling vehicle, is steered automatically by a steering control system for some portion of the path followed by the implement pulling vehicle as it travels through said open field.

54. The implement steering control method according to claim 53, wherein the implement pulling vehicle is actively steered to follow the same desired path of travel as the implement.

55. The implement steering control method according to claim 53, wherein the implement pulling vehicle is actively steered to follow a different desired path of travel than that of the implement.

56. The implement steering control method according to claim 42, further comprising:
providing a signal indicative of the roll of an implement pulling vehicle.

57. The implement steering control method according to claim 56, further comprising:
responding to said steering control signal for causing said implement to follow along a desired path of travel.

58. The implement steering control method according to claim 57, wherein said desired path of travel corresponds to a path of travel followed by said implement pulling vehicle.

59. The implement steering control method according to claim 57, wherein said desired path of travel is a recorded path of travel.

60. The implement steering control method according to claim 57, wherein said desired path of travel is within an open field having various soil conditions that includes at least one of side hills, old rows, sub-surface rip lines, and implanted plant bed rows.

61. A steering control system, comprising:
a tractor steering module for causing a tractor coupled to an implement to be actively steered along a corrected path of travel, wherein said corrected path of travel is corrected for vehicle drift caused by the terrain the tractor traverses; and
an implement steering module for causing said implement to be actively steered along another corrected path of travel, wherein said another corrected path of travel is corrected for implement drift caused by the terrain the pulled implement traverses.

62. The steering control system, according to claim 61, wherein said corrected path of travel and said another corrected path of travel are substantially the same path of travel.

63. The steering control system according to claim 61, wherein said corrected path of travel and said another corrected path of travel are both curved paths of travel.

64. The implement steering control method according to claim 36, wherein said navigation signal is further indicative of implement tilt; and wherein said implement tilt is determined by directly measuring the tilt of an implement pulled by a tractor.

65. The implement steering control method according to claim 36, wherein said navigation signal is further indicative of implement tilt; and wherein said implement tilt is determined by indirectly measuring the tilt of a vehicle pulling an implement.

66. The implement steering control method according to claim 36, wherein said navigation signal is a position measurement in a defined space; and wherein said defined space is not a furrow on ground.
